(19) United States
(12) Patent Application Publication
(10) Pub. No.: US 2008/0224998 A1
(43) Pub. Date: Sep. 18, 2008

(54) Computer Cursor Control Method and Apparatus

(75) Inventors: Chih Lung Lo, Sijhih City (TW); Wen Sheng Kuo, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP, Sijhih City (TW)

(21) Appl. No.: 12/048,509

(22) Filed: Mar. 14, 2008

(30) Foreign Application Priority Data
Mar. 16, 2007 (TW) 96109227

(51) Int. Cl. G06F 3/033

(52) U.S. Cl. 345/157; 345/163

(57) ABSTRACT

A computer cursor control apparatus operating in either the mouse mode or the non-mouse mode is determined by the switch signal. When the computer cursor control apparatus is operating in the mouse mode, the cursor-moving module calculates the cursor-moving signal and outputs it on the monitor of a host for display. On the other hand, when the computer cursor control apparatus is operating in the non-mouse mode, the cursor-moving signal and the pressuring signal, generated by the cursor-moving module and pressure sensing unit respectively, are packaged together and outputted to the host. In response to the cursor-moving signal, the host displays a moving trace on the monitor, with the thickness of the moving trace varying based on the pressuring signal.

This application claims the benefit of priority based on Taiwan Patent Application No. 096109227, filed on Mar. 16, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a computer cursor control apparatus. More particularly, the present invention relates to a computer cursor control apparatus and method for wirelessly controlling the movement of a computer cursor.

2. Descriptions of the Related Art

FIG. 1 illustrates a schematic diagram of a prior art mouse pen. With a pen-like appearance, the mouse pen can be used like an ordinary pen to control the movement of a computer cursor. In addition, the mouse pen has greater flexibility than a conventional mouse. Some mouse manufactures have even taken advantage of the pen-like appearance of the mouse pen by adding additional functions, such as inputting handwriting traces, characters, or graphics directly onto a computer screen.

Although mouse pens are currently used as digital pens, they fail to have the same writing sensitivity as that provided by a brush or a paintbrush. In addition, its handwriting trace cannot vary in thickness depending on the contact pressure exerted by the user. In view of these problems, the present inventors propose an improved technical solution.

### SUMMARY OF THE INVENTION

This invention is intended to provide a computer cursor control apparatus and a method for sensing the pressure exerted during writing to vary the moving trace of the computer cursor control apparatus as a function of sensing pressure.

One objective of this invention is to provide a computer cursor control apparatus which comprises a main body, a contact portion, a pressure sensing unit, a cursor-moving module, a control module, and a wireless transmission module. The main body has a cap, while the contact portion is disposed in the cap and exposed out of the main body. The pressure sensing unit, the cursor-moving module, and the wireless transmission module are all disposed in the main body. The pressure sensing unit is also used for contacting with the contact portion. The sensing pressure actuated from the contact portion generates a pressuring signal that is transmitted to the control module. The cursor-moving module is used for providing a cursor optical image signal to the control module. The control module is used for processing the cursor optical image signal into a cursor-moving signal. The switch signal controls the wireless transmission module to wirelessly transmit one of the cursor-moving signal and the signal packaging both the cursor-moving signal and the pressuring signal.

Another objective of this invention is to provide a computer cursor control apparatus comprising a main body, a ball, a pressure sensing unit, a light-emitting unit, a light-sensing unit, a control module, and a wireless transmission module. The main body has a cap and a light hole. The ball is disposed in the cap and exposed out of the main body. The pressure sensing unit, the light-emitting unit, the light-sensing unit, the control module, and the wireless transmission unit are all disposed in the main body. The pressure sensing unit is also used for contacting with the ball to sense the pressure actuated from the ball to output a pressuring signal to the control module. The light-emitting unit is used for emitting the light to the light hole. The light-sensing unit is used for receiving the light reflection signal from the light hole to generate a cursor optical image signal for transmission to the control module. The control module is used for processing the cursor optical image signal into a cursor-moving signal. The switch signal controls the wireless transmission module to wirelessly transmit one of the cursor-moving signal and the signal packaging both the cursor-moving signal and the pressuring signal.

Another objective of this invention is to provide a computer cursor control method for a computer cursor control apparatus to wirelessly transmit a signal to the host. The computer cursor control method comprises the following steps: detecting the displacement of the computer cursor control apparatus to generate a cursor-moving signal; sensing the pressure actuated from the computer cursor control apparatus to generate a pressuring signal; determining that a switch signal of the computer cursor control apparatus is enabled; packaging and wirelessly transmitting the cursor-moving signal and the pressuring signal from the computer cursor control apparatus to the host; translating the cursor-moving signal into a moving trace through a drive software; and displaying the moving trace on a monitor after the host receives the cursor-moving signal and the pressuring signal, wherein the moving trace has a thickness which varies according to the pressuring signal.

In accordance with the computer cursor control apparatus and the method of this invention, a cursor-moving module and a pressure sensing unit are disposed within the main body, wherein the cursor-moving module is used for detecting the moving trace of the computer cursor control apparatus. The pressure sensing unit is used for sensing the pressure actuated from the computer cursor control apparatus while the apparatus is moving. In this way, the moving trace of the computer cursor control apparatus displayed on a monitor will vary in thickness as a function of sensing pressure.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a prior art mouse pen;

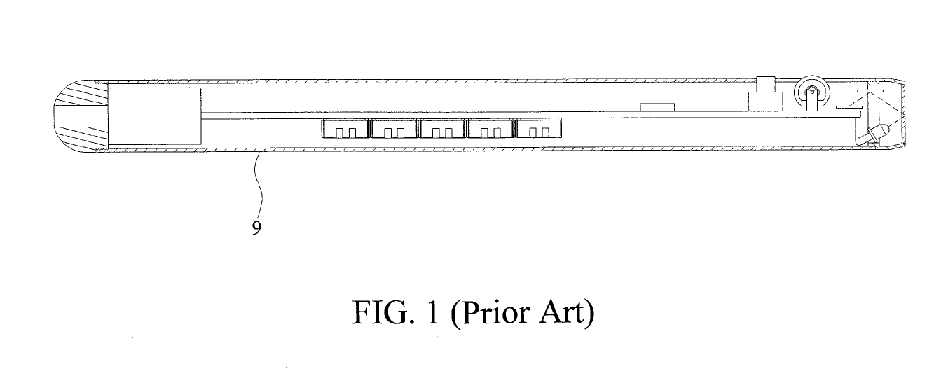

FIG. 2 is a block diagram illustrating a computer cursor control apparatus of this invention;

FIG. 3 is a schematic diagram illustrating a first embodiment of this invention;

FIG. 4 is a schematic diagram illustrating a second embodiment of this invention;

FIG. 5 is a schematic diagram illustrating a third embodiment of this invention;

FIG. 6 is a flow chart illustrating the control operations performed by the computer cursor control apparatus of this invention;

FIG. 7 is a schematic diagram illustrating a fourth embodiment of this invention; and

FIG. 8 is another flow chart illustrating the control operations performed by a computer cursor control apparatus of this invention.

### DESCRIPTION OF THE PREFERRED EMBODIMENT

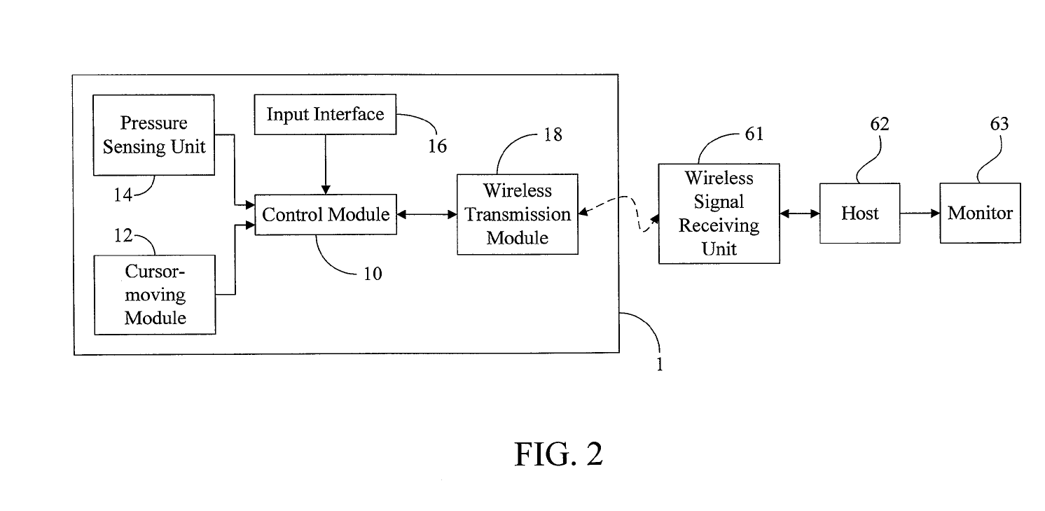

FIG. 2 illustrates a block diagram of a computer cursor control apparatus 1 of this invention. The computer cursor control apparatus 1 is used for transmitting a wireless signal to a host 62, which receives the wireless signal through a wireless signal receiving unit 61. After being processed by the host 62, the wireless signal is used as a signal for performing a computer cursor operation, a paintbrush operation, or a character recognition operation and is displayed on a monitor 63.

The computer cursor control apparatus 1 comprises a control module 10, a cursor moving module 12, a pressure sensing unit 14, an input interface 16, and a wireless transmission module 18. The control module 10 is electrically connected with the cursor-moving module 12, the pressure sensing unit 14, the input interface 16, and the wireless transmission module 18 for controlling.

The cursor-moving module 12 is used for detecting the displacement of the computer cursor control apparatus 1 then to generate a cursor optical image signal to be outputted to the control module 10. Upon receiving the cursor optical image signal, the control module 10 processes it into a cursor-moving signal for outputting.

The pressure sensing unit 14 is used for synchronously sensing the pressure actuated from the computer cursor control apparatus 1 during the movement of the computer cursor control apparatus 1 to output the pressuring signal to the control module 10. The pressuring signal mainly functions to make a moving trace of the computer cursor control apparatus 1 vary in thickness when the computer cursor control apparatus 1 is operating in the paintbrush mode.

The input interface 16 has a mouse function interface and a function switching interface. The mouse function interface may incorporate basic functions such as the left mouse button, the right mouse button, and the mouse wheel functions, and is used for inputting an operational signal to the control module 10. The input interface 16 may also incorporate additional functional buttons as desired. The function switching interface is used for switching the operation of the computer cursor control apparatus 1 between the mouse function and non-mouse function. The non-mouse function of this invention allows the computer cursor control apparatus 1 to operate in a paintbrush mode or a character recognition mode. During the operation, the function switching interface provides a switch signal to the control module 10 for the control module 10 to decide the function in which the computer cursor control apparatus 1 shall operate.

In this invention, when receiving the switch signal, the control module 10 controls the computer cursor control apparatus 1 to operate in the non-mouse function. Otherwise, when no switch signal is received, the control module 10 controls the computer cursor control apparatus 1 to operate in the mouse function.

Accordingly, when the computer cursor control apparatus 1 is operating in the mouse function, the control module 10 outputs a cursor-moving signal to the wireless transmission module 18, and controls the wireless transmission module 18 to transmit the cursor-moving signal to the host 62. Upon receiving the cursor-moving signal via the wireless signal receiving unit 61, the host 62 processes the cursor-moving signal to derive a cursor-moving direction for display on the monitor 63.

Alternatively, when the computer cursor control apparatus 1 is operating in the non-mouse function, the control module 10 packets the cursor-moving signal and the pressuring signal then outputs the signals to the wireless transmission module 18. The control module 10 also controls the wireless transmission module 18 to wirelessly transmit the cursor-moving signal and the pressuring signal to the host 62. Upon receiving the cursor-moving signal and the pressuring signal via the wireless signal receiving unit 61, the host 62 decides the functional mode according to the selected drive software, and processes the cursor-moving signal and the pressuring signal to derive a result for display on a monitor 63. Here, the selected drive software is used for executing either the paintbrush mode or the character recognition mode.

Hereinafter, the embodiments of the computer cursor control apparatus 1 will be described in detail with reference to the block diagram thereof depicted in FIG. 2.

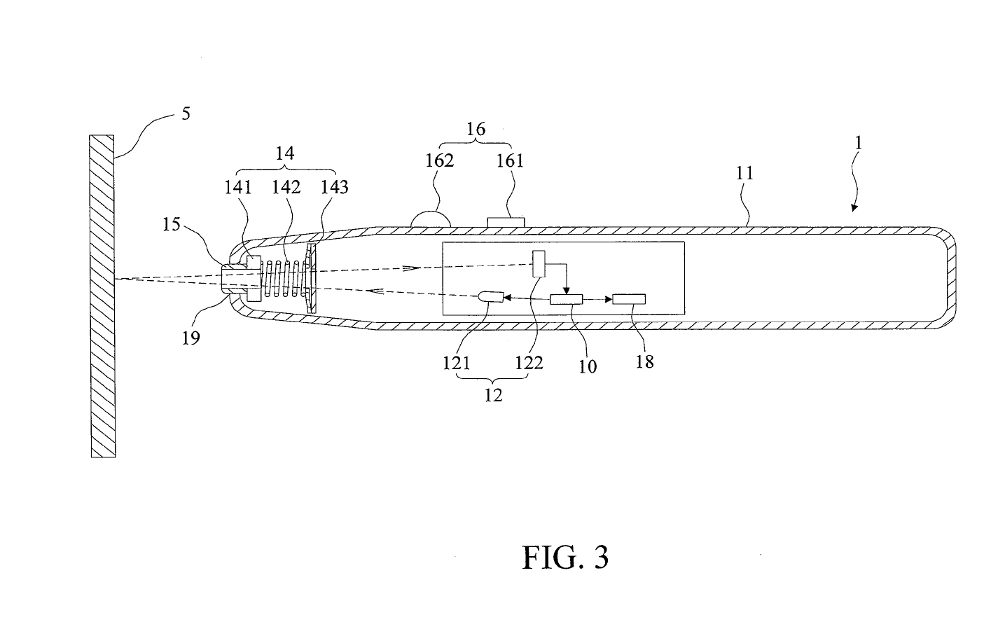

FIG. 3 illustrates a computer cursor control apparatus 1 in accordance with the first embodiment of this invention. The computer cursor control apparatus 1 comprises a cursor-moving module 12, a pressure sensing unit 14, a control module 10, and a wireless transmission module 18 disposed in the main body 11. The main body 11 is shaped as a hollow penholder and is formed with a cap 19 at a front end thereof. The cap 19 has a contact portion 15 for the computer cursor control apparatus 1 being contact with a working surface 5.

The pressure sensing unit 14 is disposed immediately adjacent to the contact portion 15 to sense the pressure actuated from the contact portion 15 and generate a pressuring signal. The pressure sensing unit 14 may be implemented by a pressure sensor 141, a flexible portion 142, and a fixed portion 143. The pressure sensor 141 is disposed immediately adjacent to one side of the contact portion 15 and is connected with the fixed portion 143 through the flexible portion 142, so that the pressure sensing unit 14 may experience a flexible deformation in response to the pressure exerted on the contact portion 15. As a result, when operated by a user, the computer cursor control apparatus 1 may yield a handwriting effect like a paintbrush or a brush. In an alternative design, those skilled in the art may readily swap the locations of the pressure sensor 141 and the fixed portion 143, in which case the pressure sensing unit 14 will also experience a flexible deformation in response to pressure.

The cursor-moving module 12 disposed in the main body 11 comprises a light-emitting unit 121 and a light-sensing unit 122. The light-emitting unit 121 is used for emitting the light through the cap 19. The emitted light is transmitted through the pressure sensing unit 14 and the contact portion 15 to the working surface 5. The light-emitting unit 121 may emit an infrared light, a laser, or a visible light. The light-sensing unit 122 is used for receiving a light reflection signal to the working surface 5 which incorporates an image variation, then outputs a cursor optical image signal to the control module 10. Consequently, as the main body 11 moves, the light reflection signals received by the light-sensing unit 122 constitute a series of light spot images, which are in turn processed by the light-sensing unit 122 to generate a cursor optical image signal. Then the control module 10 calculates the cursor-moving signal according to this cursor optical image signal.

Disposed on the outer surface of the main body 11 is an input interface 16 comprising a switch 161, a plurality of mouse buttons 162, and a mouse wheel (not shown) to facilitate the user's operation. The mouse buttons 162 serve as a left and a right mouse button, while the switch 161 is used for outputting the switch signal to the control module 10.

Functions of the control module 10 have already been described in detail with reference to FIG. 2, and therefore will not be described again herein.

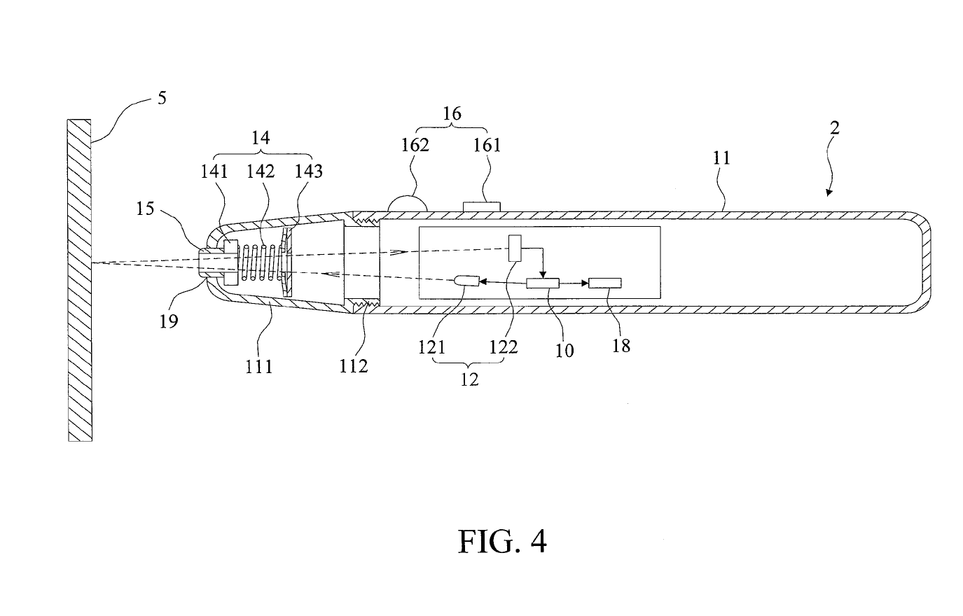

FIG. 4 illustrates a computer cursor control apparatus 2 in accordance with the second embodiment of this invention. The computer cursor control apparatus 2 of FIG. 4 differs from the computer cursor control apparatus 1 of FIG. 3 due to the head portion 111 of the main body 11 is designed as a replaceable structure and the pressure sensing unit 14 and the contact portion 15 are contained inside. The head portion 111 of the computer cursor control apparatus 2 has a connecting portion 112 for connecting with the main body 11 by means of thread, rabbet, or other movable connecting means. In this way, any element inside the head portion 111 may be replaced in case it fails to work or works improperly.

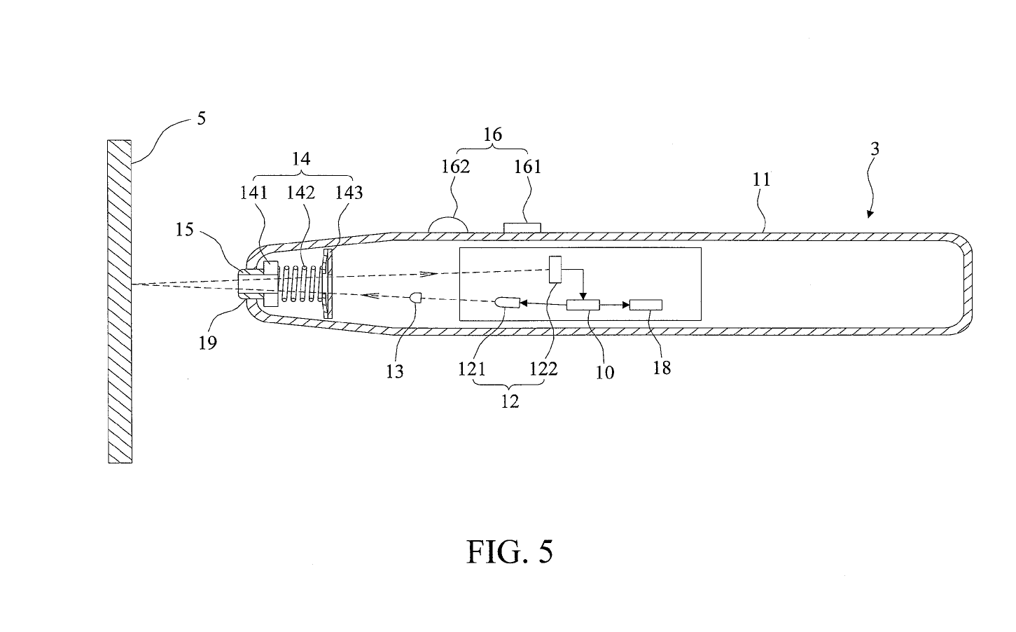

FIG. 5 illustrates a computer cursor control apparatus 3 in accordance with a third embodiment of this invention. The computer cursor control apparatus 3 of FIG. 5 differs from the computer cursor control apparatus 1 of FIG. 3 due to a lens 13 disposed additionally in the main body 11, and more specifically, in the light path of the light-emitting unit 121. The lens 13 focuses the light emitted from the light-emitting unit 121 for reducing the distance required between the computer cursor control apparatus 3 and the working surface 5 for normal operation. In this way, the computer cursor control apparatus 3 is only allowed to operate within a specific distance from the working surface 5 to avoid unnecessary false operations of the computer cursor control apparatus 3. Furthermore, if the light-emitting unit 121 emits a laser, the distance required between the computer cursor control apparatus 3 and the working surface 5 for normal operation may be controlled more effectively and precisely by controlling the light-emitting power of the light-emitting unit 121 simultaneously.

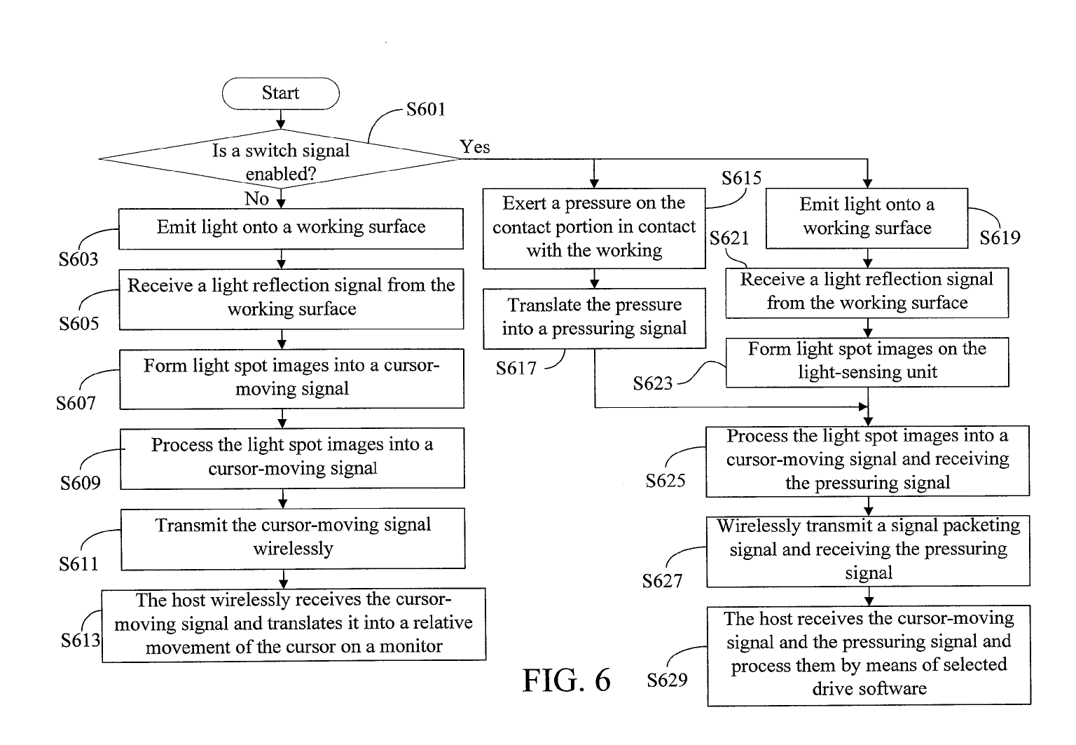

FIG. 6 illustrates a flow chart of the control operations performed by the computer cursor control apparatus of this invention. The hardware structure described herein is shown in both FIGS. 2 and 3. The control flow comprises the following steps: initially, the control module 10 determines whether the switch signal is enabled by the switch 161 (step S601), and in response to the result of the determination, the control module 10 decides whether the computer cursor control apparatus 1 should operate in a mouse function or a non-mouse function.

If the obtained result in step S601 is to disable, then the control module 10 controls the computer cursor control apparatus 1 to operate in the mouse function. As the computer cursor control apparatus 1 moves, the light-emitting unit 121 emits light onto the working surface 5 (step S603), and the light-sensing unit 122 receives a light reflection signal from the working surface 5 (step S605). Consequently, as a result of the movement of the computer cursor control apparatus 1, a series of light spot images are formed on the light-sensing unit 122 (step S607). These light spot images are then processed by the light-sensing unit 122 into a cursor optical image signal, which is in turn processed by the control module 10 into a cursor-moving signal (step S609). Subsequently, the cursor-moving signal is wirelessly transmitted via the wireless transmission module 18 to the host 62 (step S611), so that after receiving the cursor-moving signal, the host 62 translates it into the relative movement of the cursor on the monitor 63 (step S613).

On the other hand, if the answer obtained in step S601 is to enable, the control module 10 controls the computer cursor control apparatus 1 to operate in the non-mouse function. In this case, the computer cursor control apparatus 1 moves and is contacted with the working surface 5. The light-emitting unit 121 emits light onto the working surface 5 (step S619), and the light-sensing unit 122 receives a light reflection signal from the working surface 5 (step S621). Consequently, as a result of the movement of the computer cursor control apparatus 1, a series of light spot images are formed on the light-sensing unit 122 (step S623). During the execution of the steps S619 S623, a pressure is actuated from the contact portion 15 which contacts the working surface 5 (step S615), and the pressure actuated from the contact portion 15 is converted by the pressure sensing unit 14 into a pressuring signal (step S617).

Subsequent to the steps S617 and S623, these light spot images are processed by the light-sensing unit 122 into a cursor optical image signal, which is in turn processed by the control module 10 into a cursor-moving signal. At this point, the control module 10 also receives the pressuring signal (step S625). Next, the control module 10 packages the cursor-moving signal and the pressuring signal into a signal. The signal comprises both the cursor-moving signal and the pressuring signal is then transmitted via the wireless transmission module 18 to the host 62 (step S627). After receiving the cursor-moving signal and the pressuring signal, the host 62 processes the signals using the selected drive software (step S629).

In step S629, the drive software may be selected by a user. The user may select the drive software of the paintbrush mode, in which case the cursor-moving signal is displayed on the monitor 63 as a moving trace. Meanwhile, the pressuring signal accompanied with the cursor-moving signal will cause a variation in the thickness of the moving trace, hence the computer cursor control apparatus 1 can then be used by the user as a paintbrush or a brush.

Alternatively, in step S629, the user may also select the drive software of the character recognition mode. In this case, the cursor-moving signal is displayed on the monitor 63 as a moving trace, which is recognized as the corresponding characters for outputting, so the computer cursor control apparatus 1 can be used by the user as a handwriting recognizing apparatus.

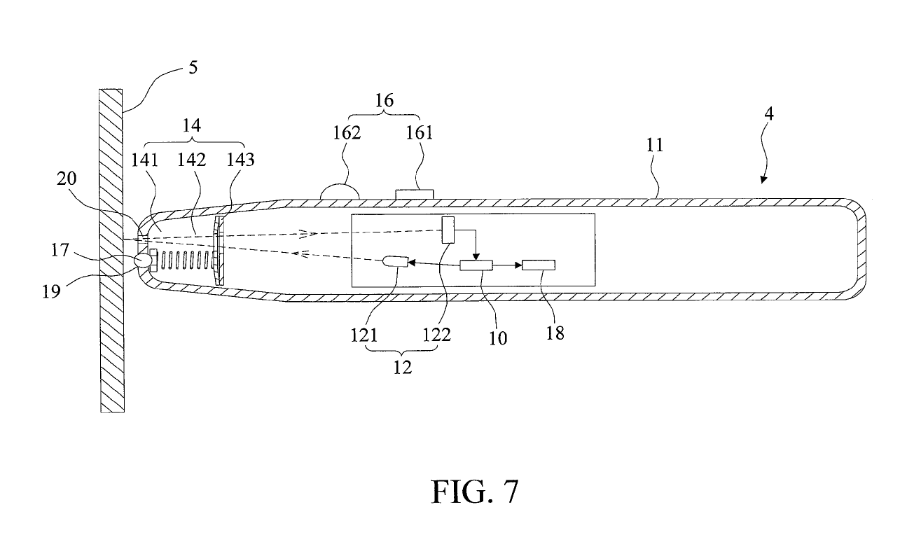

FIG. 7 illustrates a computer cursor control apparatus 4 in accordance with the fourth embodiment of this invention. The computer cursor control apparatus 4 of FIG. 7 differs from the computer cursor control apparatus 1 of FIG. 3 due to the contact portion 15 in FIG. 3 is replaced by a ball 17, and a light hole 20 is formed at one side of the cap 19. In FIG. 7, the light emitted from the light-emitting unit 121 is projected through the light hole 20 to a working surface 5, and the light-sensing unit 122 is adapted to receive a light reflection signal that incorporates an image variation from the working surface 5. Consequently, when the computer cursor control apparatus 4 operates in the mouse function, the light-sensing unit 122 will receive through the light hole 20 a light reflection signal, which will result in a series of light spot images as the main body 11 moves. Likewise, the control module 10 calculates a cursor-moving signal according to the cursor optical image signal outputted by the light-sensing unit 122.

In reference to FIG. 7, in addition to providing the pressure sensing function, the ball 17 further renders the computer cursor control apparatus 4 with an operational sense like an ordinary pen when coming into contact with the working surface 5 due to the rolling movement of the ball 17.

Primarily, the computer cursor control apparatus 4 of FIG. 7 is able to operate in either the mouse function or the non-mouse function in response to the switch signal. The way in which the computer cursor control apparatus 4 switches its function has already been described with reference to FIG. 2, and thus will not be described again herein.

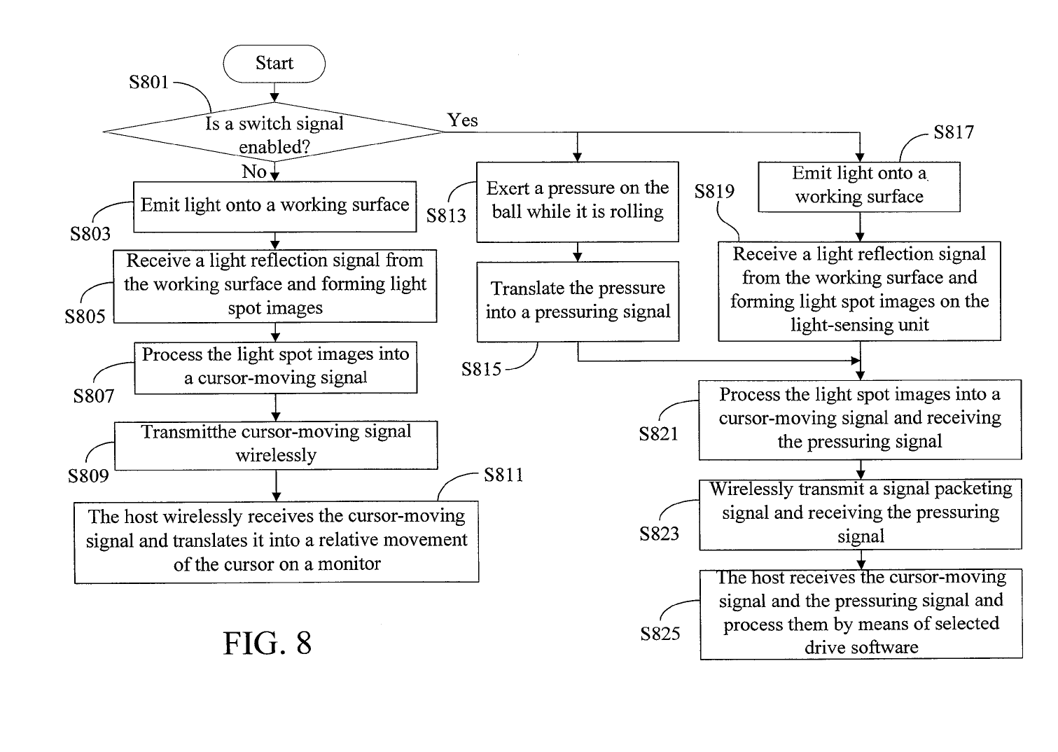

FIG. 8 illustrates another flow chart of the control operations performed by the computer cursor control apparatus of this invention. FIGS. 2 and 7 illustrate the hardware structure described herein. The control flow comprises the following steps: initially, the control module 10 determines whether the switch signal is enabled by the switch 161 (step S801), and in response to the result of the determination, the control module 10 decides whether the computer cursor control apparatus 4 should operate in a mouse function or a non-mouse function.

If the result obtained in step S801 is to disable, then the control module 10 controls the computer cursor control apparatus 4 to operate in the mouse function. As the computer cursor control apparatus 4 moves, the light-emitting unit 121 emits light through the light hole 20 onto the working surface 5 (step S803), and the light-sensing unit 122 receives a light reflection signal from the working surface 5 through the light hole 20. Consequently, as a result of movement of the computer cursor control apparatus 4, a series of light spot images are formed on the light-sensing unit 122 (step S805). These light spot images are then processed by the light-sensing unit 122 into a cursor optical image signal, which is in turn processed by the control module 10 into a cursor-moving signal (step S807). Subsequently, the cursor-moving signal is wirelessly transmitted via the wireless transmission module 18 to the host 62 (step S809), so that after receiving the cursor-moving signal, the host 62 translates it into a relative movement of the cursor on the monitor 63 (step S811).

On the other hand, if the result obtained in step S801 is to enable, the control module 10 controls the computer cursor control apparatus 4 to operate in the non-mouse function. In this case, the ball 17 of the computer cursor control apparatus 4 moves in contact with the working surface 5. The light-emitting unit 121 emits light through the light hole 20 onto the working surface 5 (step S817), and the light-sensing unit 122 receives a light reflection signal from the working surface 5. Consequently, as a result of movement of the computer cursor control apparatus 4, a series of light spot images are formed on the light-sensing unit 122 (step S819). During the execution of steps S817 and S819, the pressure is exerted on the ball 15 which comes into the contact with working surface 5 (step S813), and the pressure actuated from the ball 15 is converted by the pressure sensing unit 14 into a pressuring signal (step S815).

Subsequent to the steps S815 and S819, these light spot images are processed by the light-sensing unit 122 into a cursor optical image signal, which is in turn processed by the control module 10 into a cursor-moving signal. At this point, the control module 10 also receives the pressuring signal (step S821). Next, the control module 10 packages the cursor-moving signal and the pressuring signal into a signal. The signal, which comprises both the cursor-moving signal and the pressuring signal is then transmitted via the wireless transmission module 18 to the host 62 (step S823), so that after receiving the cursor-moving signal and the pressuring signal, the host 62 processes them using the selected drive software (step S825).

Likewise, the user may select the drive software of the paintbrush mode, in which case the cursor-moving signal is displayed on the monitor 63 as a moving trace. Meanwhile, the pressuring signal, accompanied by a cursor-moving signal, will cause variation in the thickness of the moving trace, so that the computer cursor control apparatus 4 may be used by the user as a paintbrush or a brush. Alternatively, the user may also select the drive software of the character recognition mode. In this case, the cursor-moving signal is displayed on the monitor 63 as a moving trace and is recognized as the corresponding characters for outputting, so that the computer cursor control apparatus 4 can be used by the user as a handwriting recognizing apparatus.

In summary, the computer cursor control apparatus and the method thereof disclosed in this invention are characterized by the following features:
1. The computer cursor control apparatus has a plurality of functions integrated therein, such as the functions of a mouse, as well as a paintbrush and a handwriting recognizing apparatus.
2. The user may have the same touch sensitivity as that of a paintbrush or a brush, and the handwriting trace can vary in thickness as a function of the pressure exerted by the user during the handwriting process.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer cursor control apparatus, comprising:
a main body having a cap;
a contact portion disposed in the cap and exposed out of the main body;
a pressure sensing unit, disposed in the main body and being contact with the contact portion, for sensing pressure actuated from the contact portion to generate a pressuring signal;
a cursor-moving module, disposed in the main body, for providing a cursor optical image signal;
a control module, disposed in the main body and electrically connected with the pressure sensing unit and the cursor-moving module, for processing the cursor optical image signal to generate a cursor-moving signal; and
a wireless transmission module disposed in the main body and electrically connected with the control module;
wherein the control module is adapted to control the wireless transmission module to wirelessly transmit one of the cursor-moving signal, and a packet which packaging the cursor-moving signal with the pressuring signal according to a switch signal.

2. The computer cursor control apparatus of claim 1, wherein the main body is a hollow penholder.

3. The computer cursor control apparatus of claim 1, wherein the cursor-moving module comprises:
a light-emitting unit for emitting a light through the cap on a working surface; and
a light-sensing unit for receiving a light reflection signal from the working surface to provide the cursor optical image signal.

4. The computer cursor control apparatus of claim 3, wherein the light emitted from the light-emitting unit is one of an infrared, a laser, and visible light.

5. The computer cursor control apparatus of claim 1, further comprising a lens disposed in the main body and located on one of light paths of the light-emitting unit.

6. The computer cursor control apparatus of claim 1, wherein the pressure sensing unit comprises a pressure sensor, a fixed portion, and a flexible portion, the flexible portion is disposed between the fixed portion and the pressure sensor.

7. The computer cursor control apparatus of claim 1, wherein the pressure sensing unit deposed in the main body is replaceable.

8. The computer cursor control apparatus of claim 1, further comprising an input interface, electrically connected with the control module, for generating an operation signal and the switch signal.

9. The computer cursor control apparatus of claim 8, wherein the input interface comprises a switch for generating the switch signal.

10. A computer cursor control apparatus, comprising:
a main body having a cap and a light hole;
a ball disposed in the cap and exposed out of the main body;
a pressure sensing unit, disposed in the main body and contacted with the ball, for sensing pressure actuated from the ball to generate a pressuring signal;
a light-emitting unit, disposed in the main body, for emitting a light to the light hole;
a light-sensing unit, disposed in the main body, for receiving a light reflection signal from the light hole to generate a cursor optical image signal;
a control module, disposed in the main body and electrically connected with the pressure sensing unit, the light-firing unit and the light-sensing unit, for processing the cursor optical image signal to generate a cursor-moving signal; and
a wireless transmission module disposed in the main body and electrically connected with the control module;
wherein the control module is adapted to control the wireless transmission module to wirelessly transmit one of the cursor-moving signal, and a packet which packaging the cursor-moving signal with the pressuring signal according to a switch signal.

11. The computer cursor control apparatus of claim 10, wherein the main body is a hollow penholder.

12. The computer cursor control apparatus of claim 10, wherein the light emitted from the light-emitting unit is one of an infrared, a laser, and visible light.

13. The computer cursor control apparatus of claim 10, further comprising a lens disposed in the main body and located on one of light paths of the light-emitting unit.

14. The computer cursor control apparatus of claim 10, wherein the pressure sensing unit comprises a pressure sensor, a fixed portion, and a flexible portion, the flexible portion is disposed between the fixed portion and the pressure sensor.

15. The computer cursor control apparatus of claim 10, wherein the pressure sensing unit deposed in the main body is replaced.

16. The computer cursor control apparatus of claim 10, further comprising an input interface, electrically connected with the control module, for generating an operation signal and the switch signal.

17. The computer cursor control apparatus of claim 16, wherein the input interface comprises one of a mouse button and a mouse wheel.

18. The computer cursor control apparatus of claim 16, wherein the input interface comprises a switch for generating the switch signal.

19. A computer cursor control method for a computer cursor control apparatus to wirelessly transmit a signal to a host, the computer cursor control method comprising the following steps of:
detecting displacement of the computer cursor control apparatus to generate a cursor-moving signal;
sensing pressure actuated from the computer cursor control apparatus to generate a pressuring signal;
determining that a switch signal of the computer cursor control apparatus is enabled;
packaging and wirelessly transmitting the cursor-moving signal and the pressuring signal from the computer cursor control apparatus to the host; and
translating the cursor-moving signal into a moving trace through a drive software and displaying the moving trace on a monitor after the host receives the cursor-moving signal and the pressuring signal, wherein the moving trace has a thickness being variable according to the pressuring signal.

20. The computer cursor control method of claim 19, wherein the step of detecting the displacement of the computer cursor control apparatus further comprises the following steps of:
emitting a light from inside of the computer cursor control apparatus to a working surface exposed out of the computer cursor control apparatus; and
generating the cursor-moving signal by calculating a reflection light reflected from the working surface.

21. The computer cursor control method of claim 19, wherein the pressuring signal is generated by a pressure sensing unit sensing the pressure actuated from a contact portion of the computer cursor control apparatus.

22. The computer cursor control method of claim 19, wherein the drive software is operated in a brush mode for connecting the moving trace with the pressing signal, and the thickness of the moving trace is variable according to the pressuring signal.

23. The computer cursor control method of claim 19, wherein the drive software is operated in a character mode for recognizing the moving trace as a character.

24. The computer cursor control method of claim 19, further comprising the following steps of:
determining that the switch signal of the computer cursor control apparatus is disabled; and
wirelessly transmitting the cursor-moving signal to the host.

25. The computer cursor control method of claim 19, further comprising a step of:
translating the cursor-moving signal into a cursor-moving trace after the host receives the cursor-moving signal.
